(19) United States
(12) Patent Application Publication
(10) Pub. No.: US 2026/0318199 A1
(43) Pub. Date: Oct. 15, 2026

(54) BOREHOLE SEALING DEVICE APPLICABLE TO IN-SITU PERMEABILITY TEST OF ENGINEERING ROCK MASS AND METHOD THEREOF

(71) Applicant: CHINA UNIVERSITY OF MINING AND TECHNOLOGY, Xuzhou (CN)

(72) Inventors: Jiangfeng LIU, Xuzhou (CN); Zhipeng WANG, Xuzhou (CN); Ju WANG, Xuzhou (CN); Ruinian SUN, Xuzhou (CN); Yixu ZHAO, Xuzhou (CN); Hongyang NI, Xuzhou (CN); Shijia MA, Xuzhou (CN)

(21) Appl. No.: 19/647,183

(22) Filed: Apr. 14, 2026

(30) Foreign Application Priority Data
Apr. 15, 2025 (CN) 202510467847.9

(51) Int. Cl. E21B 49/00; E21B 33/12

(52) U.S. Cl. CPC E21B 49/008; E21B 33/12

(57) ABSTRACT

Provided are a borehole sealing device applicable to an in-situ permeability test of an engineering rock mass and a method thereof, which belongs to the technical field of the in-situ gas permeability test of the engineering rock mass. The technical solutions of the present disclosure are as follows. A test device for the in-situ gas permeability test of the engineering rock mass includes a data recording device, a pressurizing valve, a gas injection valve, a first pressure gauge, a second pressure gauge, a first flexible sealing device with controllable volume variation, a second flexible sealing device with controllable volume variation and a gas injection perforated pipe. A borehole sealing method is further provided in the present disclosure, which includes S1, installing the device; S2, sealing the test hole, and S3, injecting the gas into the test hole. The beneficial effects of the present disclosure are that, in the present disclosure, the borehole sealing problem is converted into the force analysis problem through incorporating the roughness degree of the hole wall into the derivation process, and a more accurate method for setting sealing pressure is obtained by comparing the friction force provided by the hole wall with the thrust force exerted by the gas on the test section to the sealing device.

### TECHNICAL FIELD

The present disclosure relates to the technical field of the in-situ gas permeability test of the engineering rock mass, and in particular, relates to a borehole sealing device applicable to an in-situ permeability test of an engineering rock mass and a method thereof.

### BACKGROUND

Currently, in various deep geological projects, the accurate measurement of the permeability is an important task to guide the engineering practice. At present, the in-situ gas permeability test on the engineering rock mass is mainly implemented through the borehole inflation test or the borehole pressure water test based on the steady-state method. In which, the sealing of the drilled test hole is a key task. Currently, the test hole is mainly sealed by the expansion-type double rubber plug sealer, and the structure of the expansion-type double rubber plug sealer is similar to the existing mining water injection and grouting plug sealer, which is pressurized and expanded by a manual water pump to achieve the purpose of sealing the test hole. Subsequently, in order to ensure the sealing, gas with a pressure less than ⅔ of the expansion pressure of the rubber plug is injected into the hole to conduct a gas injection test.

However, a series of the pressure gradients is generally required to be set for the borehole inflation test based on the steady-state method. It is assumed that the pressure in the test hole is Pg and the pressure in the expansion plug is P1, the absolute sealing of the test section cannot be guaranteed simply by Pg≤⅔P1. Moreover, it is difficult to implement the dynamic regulation to satisfy the test sealing requirements by pressurizing the expansion plug with a manual water pump. Secondly, in generally, the mining water injection and grouting plug sealer is an integrated sealing and grouting device, which has a large size and is inconvenient to operate. Therefore, it is necessary to seek a more accurate method for setting the sealing pressure and a method for dynamically regulating the sealing pressure, and to design a related devices to achieve the purpose of reducing the size of the device and reducing the operating burden to a certain extent.

In summary, the current in-situ gas permeability testing on the engineering rock mass has the following defects.

1. The determination standard of the sealing pressure is not strict enough. The test is only conducted by setting the gas injection pressure to be less than ⅔ of the sealing pressure, the roughness of the hole wall is not taken into consideration, which may easily cause the gas leakage.

2. In the prior art, the sealing device is generally pressurized by the manual water pump, which cannot implement the dynamic sealing of the test hole to satisfy the experimental requirements.

3. In the prior art, the expansion-type double rubber plug sealer is generally adopted, and the structure of the expansion-type double rubber plug sealer is similar to that of the existing mining water injection and grouting plug sealer. The sealing device and the gas injection device of the expansion-type double rubber plug sealer are integrated and the size is relative large, which is inconvenient to operate and carry. Furthermore, for the test that the length of the test section is required to be varied, the integrated structure cannot be adjusted flexibly, so that the sealing device with various specifications are required to be manufactured and carried, which adds a burden to the on-site test. In addition, the flexible sealing device with controllable volume variation of the expansion-type double rubber plug seal generally adopted in the prior art is not flexible enough, which results in poor sealing effectiveness for the relatively fragmented holes.

### SUMMARY

The objectives of the present disclosure are to eliminate the problems in the background technology. Provided is a borehole sealing device applicable to an in-situ permeability test of an engineering rock mass and a method thereof. In the borehole sealing device, the objectives of reducing the device size and alleviating the operating burden are achieved by designing a detachable small-sized flexible sealing device with controllable volume variation and a gas injection perforated pipe. In the borehole sealing method, the more accurate method for setting the sealing pressure is obtained through performing the mechanical analysis and comparison on the sealing pressure and the test hole pressure, and the test hole pressure and the pressure of the flexible sealing device with controllable volume variation are simultaneously obtained by the data recording system to implement the dynamic regulation on the sealing pressure.

In order to achieve the above-mentioned objectives of the present disclosure, the technical solutions adopted by the present disclosure are specifically as follows. Provided is a borehole sealing device applicable to an in-situ permeability test of an engineering rock mass, the device includes a data recording device, a pressurizing valve, a gas injection valve, a first pressure gauge, a second pressure gauge, a first flexible sealing device with controllable volume variation, a second flexible sealing device with controllable volume variation and a gas injection perforated pipe, the first and second flexible sealing devices with controllable volume variation are provided with mounting holes penetrating therethrough in a vertical direction, the expansion plug can be adopted by the first and second flexible sealing devices with controllable volume variation, and the gas injection perforated pipe is slidable through the mounting holes on the first and second flexible sealing devices with controllable volume variation. A gas storage chamber is arranged inside each of the first and second flexible sealing devices with controllable volume variation. The first flexible sealing device with controllable volume variation is provided with two ports in communication with the gas storage chamber at upper and lower ends, respectively, and the second flexible sealing device with controllable volume variation is provided with a port in communication with an internal gas storage chamber of the second flexible sealing device at one end. After the external gas enters the gas storage chamber from the port, the corresponding flexible sealing device with controllable volume variation can expand outwards to strengthen the sealing with the hole wall, and can also expand inwards to reduce the diameter of the mounting hole, thereby strengthening the connection and sealing with the gas injection perforated pipe. The first and second flexible sealing devices with controllable volume variation are made of the flexible material.

A gas inlet of the pressurizing valve and a gas inlet of the gas injection valve are respectively in connection with a gas outlet of an external gas injection device. A gas outlet of the pressurizing valve is detachably connected to one port of the first flexible sealing device with controllable volume variation through a first gas tube, the other port of the first flexible sealing device with controllable volume variation is detachably connected to a gas inlet of the second flexible sealing device with controllable volume variation through a second gas tube. A gas inlet of the gas injection perforated pipe is detachably connected to a gas outlet of the gas injection valve through a third gas tube, the gas injection perforated pipe penetrates the first and second flexible sealing devices with controllable volume variation. The gas injection perforated pipe is provided with a plurality of production wells, and the production wells are located between the first and second flexible sealing devices with controllable volume variation. The data recording device, the pressurizing valve, the gas injection valve, the first pressure gauge, the second pressure gauge, the first flexible sealing device with controllable volume variation, the second flexible sealing device with controllable volume variation and the gas injection perforated pipe can be disassembled and assembled with each other, so that the technical problems in the prior art can be solved, including the integrated structure of the sealing device and the gas injection device, the relative large size and the inconvenience in operation and carrying.

The first pressure gauge is installed on the pressurizing valve, and the second pressure gauge is installed on the gas injection valve, a signal output terminal of the first pressure gauge and a signal output terminal of the second pressure gauge are respectively in connection with the signal input terminal of the data recording device, and the gas pressures detected by the first and second pressure gauges are transmitted to the data recording device, respectively.

A borehole sealing method is further provided by the present disclosure, and the method includes following steps.

In S1, the device is installed.

In S1.1, a test hole with a required diameter is drilled in a rock mass to be tested.

In S1.2, a gas injection perforated pipe is brought to pass through first and second flexible sealing devices with controllable volume variation, to enable the production wells to be located between the first and second flexible sealing devices with controllable volume variation.

In S1.3, the gas injection perforated pipe, the first flexible sealing device with controllable volume variation, and the second flexible sealing device with controllable volume variation are assembled and then installed as a whole into the test hole on the rock mass to be tested, that is, the assembled gas injection perforated pipe, the first flexible sealing device with controllable volume variation, and the second flexible sealing device with controllable volume variation are placed as a whole into the test hole. When the length of the test section is required to be varied, the adjustment on the distance between the first flexible sealing device with controllable volume variation and the second flexible sealing device with controllable volume variation is merely required during installing to enhance the applicability.

In S1.4, a gas inlet of the pressurizing valve is in connection with an external gas injection device. A gas outlet of the pressurizing valve is in connection with the first flexible sealing device with controllable volume variation through a first gas tube. The first flexible sealing device with controllable volume variation is in connection with the second flexible sealing device with controllable volume variation through a second gas tube. The gas inlet of the gas injection valve is in connection with the external gas injection device, and a gas outlet of the gas injection valve is in connection with a gas inlet of the gas injection perforated pipe through a third gas tube.

In S1.5, a first pressure gauge and a second pressure gauge are respectively connected to the data recording device through a signal.

In S2, the test hole is sealed.

In S2.1, a test pressure in the test hole is simulated and set as P_{g}. Firstly, the gas injection valve is kept to be closed and the external gas injection device is opened to inject test gas into the gas injection valve by the external gas injection device, such that the test gas does not enter the gas injection perforated pipe through the gas injection valve, and a pressure obtained by the data recording device is the initial pressure P′ between the external gas injection device and the gas injection valve. The initial pressure P′ is slightly more than the test pressure P_{g} set in the test plan. When the gas injection valve is opened, the pressure of the test gas is decreased from P′ to P_{g} after entering the gas injection perforated pipe by means of calculation in advance. The sealing pressure P₁ in the first and second flexible sealing devices with controllable volume variation is calculated according to Formula (1) and the test pressure P_{g}.

Formula (1) is

$${P}_{1} \geq \frac{( {r}_{2}^{2} - {r}_{1}^{2} )}{1.6 {ur}_{2} h} \cdot {P}_{g} ,$$

where P₁ denotes the sealing pressure, P_{g} denotes the test pressure, r₂ denotes an outer diameter of the first flexible sealing device with controllable volume variation, r₁ denotes an inner diameter of the first flexible sealing device with controllable volume variation, u denotes a static friction coefficient for a hole wall and h denotes a height of the first flexible sealing device with controllable volume variation.

In S2.2, the gas with the sealing pressure P₁ calculated in S2.1 is injected into the first and second flexible sealing devices with controllable volume variation by the external gas injection device, and then a sealing is completed, and the sealing pressure P₁ is capable of sealing the test pressure P_{g} of the gas in the test hole after the gas injection valve is opened.

In S3, gas is injected into the test hole.

In S3.1, the gas injection valve is opened, the test gas enters the gas injection perforated pipe through the gas injection valve and then flows into a test section of the test hole from the production well of the gas injection perforated pipe. The initial pressure P′ is decreased to the test pressure P_{g} set in the test plan right now. When the first test is started, the test gas is penetrated into the atmosphere through the rock mass, and the pressure is gradually decreased. The pressure variation in the test hole is detected and recorded by the data recording device through the second pressure gauge, simultaneously. When the test pressure P_{g} is decreased to the atmospheric pressure value, then the first test is terminated.

In S3.2, after the first test is terminated, since the sealing pressure in the first and second flexible sealing devices with controllable volume variation is sufficient to seal the test section right now, the gas injection valve is not required to be closed, and the step S3.1 is repeated, the test gas with the pressure higher than a previous pressure set in the test plan is directly injected into the gas injection perforated pipe through the external gas injection device, that is, the gas with a higher pressure is injected repeatedly. A pressure variation in the test hole is continuously detected and recorded by the data recording device, and the sealing pressure P₁ to be required is calculated by Formula (1) in real time, and the sealing gas with a corresponding pressure is respectively injected by the external gas injection device into the first and second flexible sealing device with controllable volume variation in real time according to the calculated sealing pressure P₁, so that the test hole is dynamically sealed. In the actual borehole inflation test based on the steady-state method, after the injection flow rate is varied, the sealing pressure of the flexible sealing device with controllable volume variation is adjusted in real time according to the measured pressure in the test hole to complete the dynamic regulation on the borehole sealing operation.

Further, a derivation process of Formula (1) is as follows.

In S2.11, the test pressure in the test hole is assumed to be P_{g}, and the sealing pressure in the flexible sealing device with controllable volume variation is assumed to be P₁, a force analysis on the first flexible sealing device with controllable volume variation is performed, interaction forces P1 and P1′ between the first flexible sealing device with controllable volume variation and a wall in a horizontal direction are equal with each other in magnitude and opposite to each other in direction, the first flexible sealing device with controllable volume variation is kept balanced in terms of force in a horizontal direction, in the vertical direction, an upward force F_{g} exerted by the gas in the test hole and a downward friction force F_{f} provided by the wall of the test hole are applied to the first flexible sealing device with controllable volume variation, so a leakage of the gas in the test hole is mainly related to the balance in the vertical direction.

In S2.12, an analysis is performed on the friction force, a maximum static friction force that the test hole wall can provide is F_{f}=u·F₁, where u denotes a static friction coefficient for the test hole wall, and F₁ denotes an extrusion force exerted by the first flexible sealing device with controllable volume variation on the hole wall and a magnitude of F₁ is equal to a normal stress on the hole wall multiplied by a contact area between the first flexible sealing device with controllable volume variation and the hole wall, namely, a lateral area of the first flexible sealing device with controllable volume variation. An inner diameter of the first flexible sealing device with controllable volume variation is assumed to be r₁, an outer diameter of the first flexible sealing device with controllable volume variation is assumed to be r₂, and a height of the first flexible sealing device with controllable volume variation is assumed to be h, then the lateral area of the first flexible sealing device with controllable volume variation is S₁=2πr₂h, so that the maximum static friction force is F_{f}=u·F₁=u·P₁·S₁=2uπr₂ hP₁.

In S2.13, an analysis is performed on the upward force exerted by the gas in the test hole on the first flexible sealing device with controllable volume variation, the test pressure F_{g} is equal to the normal stress at the bottom of the first flexible sealing device with controllable volume variation multiplied by the contact area S₂ between the gas and the flexible sealing device with controllable volume variation, where S₂=π(r₂²−r₁²), so that F_{g}=P_{g}·S₂=π(r₂²−r₁²)P_{g}.

Therefore, when F_{g}≤F_{f}, no gas leakage occurs, namely, π(r₂²−r₁²)P_{g}≤2uπr₂hP₁, and π(r₂²−r₁²)P_{g}≤2uπr₂hP₁ is simplified to

$${P}_{1} \geq \frac{( {r}_{2}^{2} - {r}_{1}^{2} )}{2 {ur}_{2} h} \cdot {P}_{g} .$$

In S2.14, in consideration of the cases where an incomplete contact area exists between the flexible sealing device with controllable volume variation and the test hole wall, the expansion of the flexible sealing device with controllable volume variation is mainly in the middle section, in order to ensure the sealing performance, the effective sealing area is taken as 80% of the actual lateral area of the flexible sealing device with controllable volume variation, namely, F_{g}≤0.8F_{f}, π(r₂²−r₁²)P_{g}≤2uπr₂hP₁ is simplified to

$${P}_{1} \geq \frac{( {r}_{2}^{2} - {r}_{1}^{2} )}{1.6 {ur}_{2} h} \cdot {P}_{g} .$$

Therefore, when the pressure of the flexible sealing device with controllable volume variation and the pressure of the test hole satisfy Formula (1), the sealing is considered as effective.

In comparison with the prior art, the present disclosure has the following beneficial effects.

1. Provided in present disclosure is a borehole sealing method for the in-situ gas permeability test of the engineering rock mass implemented by combining the mechanical analysis. The borehole sealing problem is converted into a force analysis problem by incorporating the roughness of the borehole wall into the derivation process, and a more accurate method for setting the sealing pressure is obtained through comparing the friction force provided by the borehole wall with the thrust force exerted by the gas of test section on the sealing device, which solves the problems in traditional sealing method that the setting on the sealing pressure lacks a scientific basis and is difficult to guarantee the sealing on test hole with different roughness, and implements the effective sealing on the test hole in different scenarios.

2. In present disclosure, a mechanism for timely monitoring and dynamically regulating the sealing pressure and the test hole pressure are provided. The sealing pressure and the pressure in the test hole can be monitored in real time by adding a corresponding pressure sensor to the test device and connecting the corresponding pressure sensor to the data recording system, and the sealing effect is evaluated by the method for setting sealing pressure setting mentioned in Formula (1) in real time, the sealing pressure to be required in real time is provided according to the variation of the pressure in the hole, which solves the problem that the traditional borehole sealing is difficult to implement the dynamic sealing on the borehole, and improves the sealing effect under different test solutions.

3. In the present disclosure, the sealing device is detachable from the gas injection device through adopting a detachable flexible material to manufacture the flexible sealing device with controllable volume variation and reducing the size of the device, and the length of the test section can be adjusted randomly, which solves the problems of large size, easy increase in the test burden, and inability to flexibly vary the length of the test section in the traditional integrated expansion double-rubber plug sealer, significantly improving the efficiency of the test. The gap between the broken rock mass and the sealing device can be properly filled by adopting the flexible material and increasing the flexibility of the sealing device during the sealing process, which solves the problems that the traditional sealing device has a relative hard outer wall and poor sealing effect on the broken rock mass, and significantly ensures the sealing effect.

### BRIEF DESCRIPTION OF THE DRAWINGS

The accompanying drawings are used to provide further understanding on the present disclosure and constitute one part of the description. The accompanying drawings are used to explain the present disclosure together with the embodiments of the present disclosure but do not constitute a limitation on the present disclosure.

FIG. 1 illustrates a schematic diagram of a principle for analyzing a sealing pressure of the present disclosure.

FIG. 2 illustrates a schematic structural diagram of a test device of the present disclosure.

### DETAILED DESCRIPTION OF THE EMBODIMENTS

In order to make the objectives, technical solutions and advantages of the present disclosure more clear and understandable, the present disclosure will be further described in detail below with reference to the accompanying drawings and embodiments. Certainly, the specific embodiments described herein are merely used to explain the present disclosure and are not intended to limit the present disclosure.

### EMBODIMENT

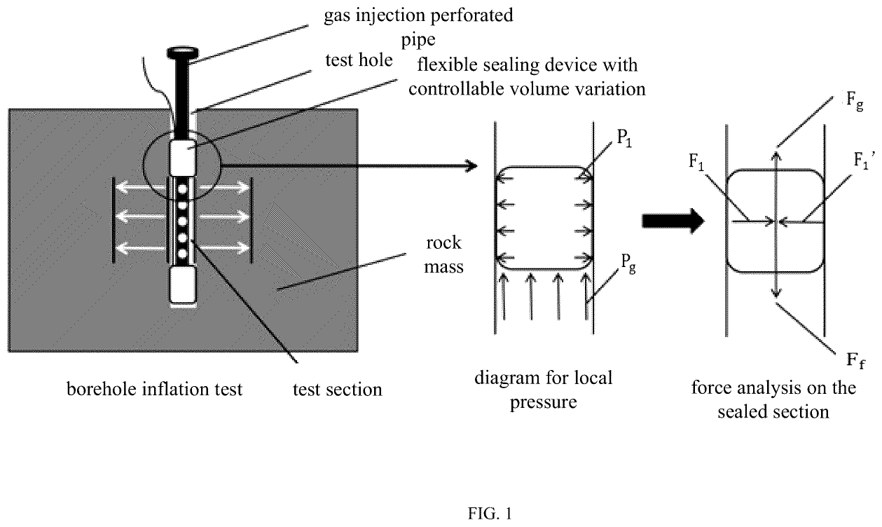

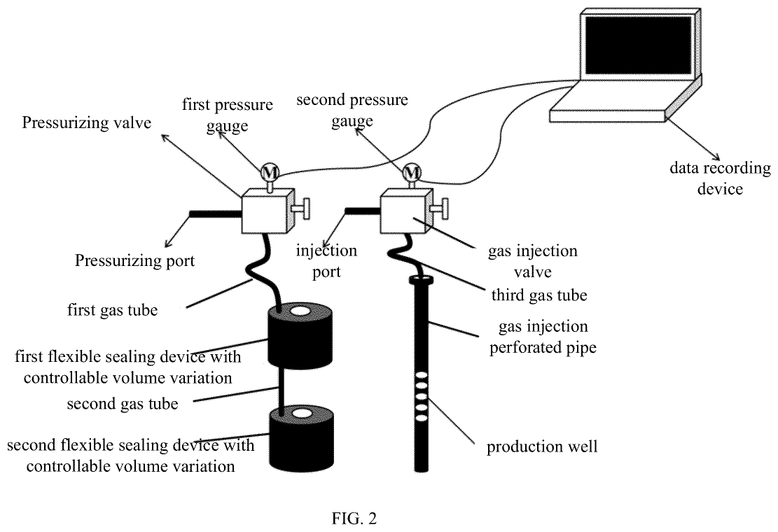

As illustrated in FIG. 1 and FIG. 2, a borehole sealing device applicable to an in-situ permeability test of an engineering rock mass is provided in this embodiment. The device includes a data recording device, a pressurizing valve, a gas injection valve, a first pressure gauge, a second pressure gauge, a first flexible sealing device with controllable volume variation, a second flexible sealing device with controllable volume variation, and a gas injection perforated pipe. The first and second flexible sealing devices with controllable volume variation are provided with mounting holes penetrating therethrough in a vertical direction. The gas injection perforated pipe is slidable through the mounting holes on the first and second flexible sealing devices with controllable volume variation. The expansion plug can be adopted by the first and second flexible sealing devices with controllable volume variation. Agas storage chamber is arranged inside each of the first and second flexible sealing devices with controllable volume variation. The first flexible sealing device with controllable volume variation is provided with two ports in communication with the gas storage chamber at upper and lower ends, respectively, and the second flexible sealing device with controllable volume variation is provided with a port in communication with the internal gas storage chamber at one end. After the external gas enters the gas storage chamber from the port, the corresponding flexible sealing device with controllable volume variation can expand outwards to strengthen the sealing with the hole wall, and can also expand inwards to reduce the diameter of the mounting hole, thereby strengthening the connection and sealing with the gas injection perforated pipe. The first and second flexible sealing devices with controllable volume variation are made of the flexible material. The gas inlet of the pressurizing valve and the gas inlet of the gas injection valve are respectively in connection with the gas outlet of the external gas injection device. The gas outlet of the pressurizing valve is detachably connected to one port of the first flexible sealing device with controllable volume variation through the first gas tube, the other port of the first flexible sealing device with controllable volume variation is detachably connected to the gas inlet of the second flexible sealing device with controllable volume variation through the second gas tube. The gas inlet of the gas injection perforated pipe is detachably connected to the gas outlet of the gas injection valve through the third gas tube, the gas injection perforated pipe penetrates the first and second flexible sealing devices with controllable volume variation. The gas injection perforated pipe is provided with a plurality of production wells, and the production wells are located between the first and second flexible sealing devices with controllable volume variation. The data recording device, the pressurizing valve, the gas injection valve, the first pressure gauge, the second pressure gauge, the first flexible sealing device with controllable volume variation, the second flexible sealing device with controllable volume variation and the gas injection perforated pipe can be disassembled and assembled with each other, so that the technical problems in the prior art can be solved, including the integrated structure of the sealing device and the gas injection device, the relative large size and the inconvenience in operation and carrying. The first pressure gauge is installed on the pressurizing valve, and the second pressure gauge is installed on the gas injection valve, the signal output terminal of the first pressure gauge and the signal output terminal of the second pressure gauge are respectively in connection with the signal input terminal of the data recording device, and the gas pressures detected by the first and second pressure gauges are transmitted to the data recording device, respectively.

In order to achieve the effects of the above-mentioned invention, a borehole sealing method is provided in the present disclosure, and the method includes the following steps.

In S1, a device is installed.

In S1.1, a test hole with a required diameter is drilled in a rock mass to be tested.

In S1.2, a gas injection perforated pipe is passed through the first and second flexible sealing devices with controllable volume variation to allow the production wells to be located between the first and second flexible sealing devices with controllable volume variation.

In S1.3, the gas injection perforated pipe, the first flexible sealing device with controllable volume variation, and the second flexible sealing device with controllable volume variation are assembled and then installed as a whole into the test hole on the rock mass to be tested, that is, the assembled gas injection perforated pipe, the first flexible sealing device with controllable volume variation, and the second flexible sealing device with controllable volume variation are placed as a whole into the test hole. When the length of the test section is required to be varied, the adjustment on the distance between the first flexible sealing device with controllable volume variation and the second flexible sealing device with controllable volume variation is merely required during installing to enhance the applicability.

In S1.4, the gas inlet of the pressurizing valve is in connection with the external gas injection device. The gas outlet of the pressurizing valve is in connection with the first flexible sealing device with controllable volume variation through the first gas tube. The first flexible sealing device with controllable volume variation is in connection with the second flexible sealing device with controllable volume variation through the second gas tube. The gas inlet of the gas injection valve is in connection with the external gas injection device, and the gas outlet of the gas injection valve is in connection with the gas inlet of the gas injection perforated pipe through the third gas tube.

In S1.5, the first pressure gauge and the second pressure gauge are respectively in signal connection with the data recording device.

In S2, a test hole is sealed.

In S2.1, the test pressure in the test hole is simulated and set as P_{g}. Firstly, the gas injection valve is kept to be closed and the external gas injection device is opened to inject the test gas into the gas injection valve by the external gas injection device. At this stage, the test gas does not enter the gas injection perforated pipe through the gas injection valve, and the pressure obtained by the data recording device is the initial pressure P′ between the external gas injection device and the gas injection valve. The initial pressure P′ is slightly more than the test pressure P_{g} set in the test plan. When the gas injection valve is opened, the pressure of the test gas is decreased from P′ to P_{g} after entering the gas injection perforated pipe by means of calculation in advance. The sealing pressure P₁ in the first and second flexible sealing devices with controllable volume variation is calculated according to Formula (1) and the test pressure P_{g}.

Formula (1) is

$${P}_{1} \geq \frac{( {r}_{2}^{2} - {r}_{1}^{2} )}{1.6 {ur}_{2} h} \cdot {P}_{g} ,$$

where P₁ denotes a sealing pressure, P_{g} denotes a test pressure, r₂ denotes an outer diameter of the first flexible sealing device with controllable volume variation, r₁ denotes an inner diameter of the first flexible sealing device with controllable volume variation, u denotes a static friction coefficient for the borehole wall and h denotes a height of the first flexible sealing device with controllable volume variation.

In S2.2, the gas with the sealing pressure P₁ calculated in S2.1 is injected into the first and second flexible sealing devices with controllable volume variation by the external gas injection device, and at this time instant, the sealing is completed, and the sealing pressure P₁ is capable of sealing the test pressure P_{g} of the gas in the test hole after the gas injection valve is opened.

In S3, the gas is injected into the test hole.

In S3.1, the gas injection valve is opened, the test gas enters the gas injection perforated pipe through the gas injection valve and then enters the test section of the test hole from the production well of the gas injection perforated pipe. At this time instant, the initial pressure P′ is decreased to the test pressure P_{g} set in the test plan. When the first test is started, the test gas is penetrated into the atmosphere through the rock mass, and the pressure is gradually decreased. During this process, the pressure variation in the test hole is detected and recorded by the data recording device through the second pressure gauge. When the test pressure P_{g} is decreased to the atmospheric pressure value, then the first test is terminated.

In S3.2, after the first test is terminated, since the sealing pressures in the first and second flexible sealing devices with controllable volume variation are sufficient to seal the test section at this stage, the gas injection valve is not required to be closed, and the step S3.1 is repeated, the test gas with the pressure higher than the previous pressure set in the test plan is directly injected into the gas injection perforated pipe through the external gas injection device, that is, the gas with a higher pressure is injected repeatedly. The pressure variation in the test hole is continuously detected and recorded by the data recording device, and the sealing pressure P₁ to be required is calculated by Formula (1) in real time, and the sealing gas with a corresponding pressure is respectively injected by the external gas injection device into the first and second flexible sealing device with controllable volume variation in real time according to the calculated sealing pressure P₁, so that the test hole is dynamically sealed. In the actual borehole inflation test based on the steady-state method, after the injection flow rate is varied, the sealing pressure of the flexible sealing device with controllable volume variation is adjusted in real time according to the measured pressure in the test hole to complete the dynamic regulation on the borehole sealing operation.

As illustrated in FIG. 1, the derivation process of Formula (1) is as follows.

The test pressure in the test hole is assumed to be P_{g}, and the sealing pressure in the flexible sealing device with controllable volume variation is assumed to be P₁, the force analysis on the first flexible sealing device with controllable volume variation is performed, the interaction forces P1 and P1′ between the first flexible sealing device with controllable volume variation and a wall in the horizontal direction are equal with each other in magnitude and opposite to each other in direction, the first flexible sealing device with controllable volume variation is kept balanced in terms of force in the horizontal direction, in the vertical direction, an upward force F_{g} exerted by the gas in the test hole and a downward friction force F_{f} provided by the wall of the test hole are applied to the first flexible sealing device with controllable volume variation, so that a leakage of the gas in the test hole is mainly related to the balance in the vertical direction.

For the friction, the maximum static friction force that the test hole wall can provide is F_{f}=u·F₁, where u denotes a static friction coefficient for the test hole wall, and F₁ denotes an extrusion force exerted by the first flexible sealing device with controllable volume variation on the hole wall and a magnitude of F₁ is equal to the normal stress on the hole wall multiplied by the contact area between the first flexible sealing device with controllable volume variation and the hole wall, that is, the lateral area of the first flexible sealing device with controllable volume variation. The inner diameter of the first flexible sealing device with controllable volume variation is assumed to be r₁, the outer diameter is assumed to be r₂, and the height is assumed to be h, then the lateral area of the first flexible sealing device with controllable volume variation is S₁=2πr₂h, so that the maximum static friction force is F_{f}=u·F₁=u·P₁·S₁=2uπr₂ hP₁.

For the upward force exerted by the gas in the test hole on the first flexible sealing device with controllable volume variation, the test pressure F_{g} is equal to the normal stress at the bottom of the first flexible sealing device with controllable volume variation multiplied by the contact area S₂ between the gas and the flexible sealing device with controllable volume variation, where S₂=π(r₂²−r₁²), so that F_{g}=P_{g}·S₂=π(r₂²−r₁²)P_{g}.

Therefore, when F_{g}≤F_{f}, no gas leakage occurs, that is, π(r₂²−r₁²)P_{g}≤2uπr₂ hP₁, which can be simplified to

$${P}_{1} \geq \frac{( {r}_{2}^{2} - {r}_{1}^{2} )}{2 {ur}_{2} h} \cdot {P}_{g} .$$

In S2.14, in consideration of the cases where an incomplete contact area exists between the flexible sealing device with controllable volume variation and the test hole wall, the expansion of the flexible sealing device with controllable volume variation is mainly in the middle section, in order to ensure the sealing performance, the effective sealing area is taken as 80% of the actual lateral area of the flexible sealing device with controllable volume variation. In this situation, F_{g}≤0.8F_{f}, which can be simplified to

$${P}_{1} \geq \frac{( {r}_{2}^{2} - {r}_{1}^{2} )}{1.6 {ur}_{2} h} \cdot {P}_{g} .$$

Therefore, when the pressure of the flexible sealing device with controllable volume variation and the pressure of the test hole satisfy Formula (1), the sealing is considered as effective.

Therefore, a borehole sealing method for the in-situ gas permeability test of the engineering rock mass implemented by combining the mechanical analysis is proposed by the present disclosure. In the present disclosure, the borehole sealing problem is converted into the force analysis problem through incorporating the roughness of the hole wall into the derivation process, and a more accurate method for setting the sealing pressure is obtained through comparing the friction force provided by the hole wall with the thrust force exerted by the gas in the test section on the sealing device, which solves the problems in conventional sealing methods that the sealing pressure setting lacks a scientific basis and is difficult to ensure the effective sealing of the test holes with different roughness, and implements the effective sealing on the test holes in different scenarios.

In summary, in the test device, the objectives of reducing the device size and alleviating the operating burden are achieved by designing a detachable small-sized flexible sealing device with controllable volume variation and a gas injection perforated pipe. In the test method, the more accurate method for setting the sealing pressure is obtained through performing the mechanical analysis and comparison on the sealing pressure and the test hole pressure, and the test hole pressure and the pressure of the flexible sealing device with controllable volume variation are simultaneously obtained by the data recording system to implement the dynamic regulation on the sealing pressure.

The above are merely the preferred embodiments of the present disclosure and are not intended to limit the present disclosure, the modifications, equivalent substitutions, improvements, and the like made within the spirit and principles of the present disclosure should be included in the protection scope of the present disclosure.

What is claimed is:

1. A borehole sealing device applicable to an in-situ permeability test of an engineering rock mass, wherein the device comprises a data recording device, a pressurizing valve, a gas injection valve, a first pressure gauge, a second pressure gauge, a first flexible sealing device with controllable volume variation, a second flexible sealing device with controllable volume variation, and a gas injection perforated pipe;
a gas inlet of the pressurizing valve and a gas inlet of the gas injection valve are respectively in connection with a gas outlet of an external gas injection device, a gas outlet of the pressurizing valve is detachably connected to one port of the first flexible sealing device with controllable volume variation through a first gas tube, another port of the first flexible sealing device with controllable volume variation is detachably connected to a gas inlet of the second flexible sealing device with controllable volume variation through a second gas tube, a gas inlet of the gas injection perforated pipe is detachably connected to a gas outlet of the gas injection valve through a third gas tube, the gas injection perforated pipe penetrates the first flexible sealing device with controllable volume variation and the second flexible sealing device with controllable volume variation, the gas injection perforated pipe is provided with a plurality of production wells, and the plurality of production wells are located between the first flexible sealing device with controllable volume variation and the second flexible sealing device with controllable volume variation;
the first pressure gauge is installed on the pressurizing valve, and the second pressure gauge is installed on the gas injection valve, a signal output terminal of the first pressure gauge and a signal output terminal of the second pressure gauge are respectively in connection with a signal input terminal of the data recording device.

2. A borehole sealing method, based on the borehole sealing device applicable to the in-situ permeability test of the engineering rock mass according to claim 1, comprises following steps:
S1, installing the device;
S1.1, drilling a test hole with a required diameter in a rock mass to be tested;
S1.2, bringing a gas injection perforated pipe to pass through a first flexible sealing device with controllable volume variation and a second flexible sealing device with controllable volume variation, enabling production wells of the gas injection perforated pipe to be located between the first flexible sealing device with controllable volume variation and the second flexible sealing device with controllable volume variation;
S1.3, installing, after the gas injection perforated pipe, the first flexible sealing device with controllable volume variation and the second flexible sealing device with controllable volume variation are assembled, the assembled gas injection perforated pipe, the first flexible sealing device with controllable volume variation and the second flexible sealing device with controllable volume variation as a whole in the test hole on the rock mass to be tested;
S1.4, connecting a gas inlet of the pressurizing valve to an external gas injection device; connecting, through a first gas tube, a gas outlet of the pressurizing valve to the first flexible sealing device with controllable volume variation; connecting, through a second gas tube, the first flexible sealing device with controllable volume variation to the second flexible sealing device with controllable volume variation; connecting a gas inlet of the gas injection valve to the external gas injection device; and connecting, through a third gas tube, a gas outlet of the gas injection valve with a gas inlet of the gas injection perforated pipe; and
S1.5, connecting, through a signal, a first pressure gauge and a second pressure gauge to a data recording device, respectively;
S2, sealing the test hole;
S2.1, simulating and setting a test pressure in the test hole as P_{g}, firstly, keeping the gas injection valve to be closed and opening the external gas injection device to inject test gas into the gas injection valve through the external gas injection device, such that the test gas does not enter the gas injection perforate pipe by the gas injection valve, a pressure obtained by the data recording device being an initial pressure P′ between the external gas injection device and the gas injection valve, calculating, according to Formula (1) and the test pressure P_{g}, a sealing pressure P₁ in the first flexible sealing device with controllable volume variation and the second flexible sealing device with controllable volume variation,
wherein Formula (1) is:
$${P}_{1} \geq \frac{( {r}_{2}^{2} - {r}_{1}^{2} )}{1.6 {ur}_{2} h} \cdot {P}_{g} ,$$
where P₁ denotes the sealing pressure, P_{g} denotes the test pressure, r₂ denotes an outer diameter of the first flexible sealing device with controllable volume variation, r₁ denotes an inner diameter of the first flexible sealing device with controllable volume variation, u denotes a static friction coefficient for a hole wall, and h denotes a height of the first flexible sealing device with controllable volume variation;
S2.2, injecting, by the external gas injection device, the test gas with the sealing pressure P₁ calculated in S2.1 into the first and second flexible sealing devices with controllable volume variations, and then completing a sealing, wherein the sealing pressure P₁ is capable of sealing the test pressure P_{g} of the gas in the test hole after the gas injection valve is opened; and
S3, injecting gas into the test hole;
S3.1, opening the gas injection valve, allowing, through the gas injection valve, the test gas to enter the gas injection perforated pipe and then flow into a test section of the test hole from the production well of the gas injection perforated pipe, decreasing the initial pressure P′ to the test pressure P_{g} set in a test plan right now, penetrating, when starting a first test, the test gas into atmosphere through the rock mass, decreasing the pressure gradually, detecting and recording a pressure variation in the test hole by the data recording device through the second pressure gauge simultaneously, and terminating, when decreasing the test pressure P_{g} to an atmospheric pressure value, the first test;
S3.2, repeating, after terminating the first test, Step 3.1 to directly inject the test gas with the pressure higher than a previous pressure set in the test plan into the gas injection perforated pipe through the external gas injection device; continuously detecting and recording, by the data recording device, a pressure variation in the test hole; calculating, based on Formula (1), a sealing pressure P₁ to be required in real time, and injecting, by the external gas injection device, sealing gas with a corresponding pressure into the first flexible sealing device with controllable volume variation and the second flexible sealing device with controllable volume variation based on the calculated sealing pressure P₁ in real time to dynamically seal the test hole, wherein since the sealing pressure in the first flexible sealing device with controllable volume variation is sufficient to seal the test section right now, the gas injection valve is not required to be closed.

3. The borehole sealing method according to claim 2, wherein in Step 2.1, a derivation process of Formula (1) includes:
S2.11, assuming the test pressure in the test hole to be P_{g}, assuming the sealing pressure in the first flexible sealing with controllable volume variation to be P₁; and performing a force analysis on the first flexible sealing device with controllable volume variation, namely, interaction forces P₁ and P₁′ between the first flexible sealing device with controllable volume variation and a wall in a horizontal direction that are equal with each other in magnitude and opposite to each other in direction, so keeping the first flexible sealing device with controllable volume variation balanced in terms of force in a horizontal direction, in a vertical direction, applying an upward force F_{g} exerted by the gas in the test hole and a downward friction force F_{f} provided by the test hole wall to the first sealing device with controllable volume variation, so mainly relating a leakage of the gas in the test hole to a balance in the vertical direction;
S2.12, performing an analysis on the friction force, wherein a maximum static friction force that the test hole wall provides is F_{f}=u·F₁, where u denotes a static friction coefficient for a test hole wall, and F₁ denotes an extrusion force exerted by the first flexible sealing device with controllable volume variation on the hole wall and a magnitude of F₁ is equal to a normal stress on the hole wall multiplied by a contact area between the first flexible sealing device with controllable volume variation and the hole wall, namely, a lateral area of the first flexible sealing device with controllable volume variation, an inner diameter of the first flexible sealing device with controllable volume variation is assumed to be r₁, an outer diameter of the first flexible sealing device with controllable volume variation is assumed to be r₂, and a height of the first flexible sealing device with controllable volume variation is assumed to be h, then the lateral area of the first flexible sealing device with controllable volume variation is S₁=2πr₂h, so that the maximum static friction force is F_{f}=u·F₁=u·P₁·S₁=2uπr₂ hP₁;
S2.13, performing an analysis on the upward force exerted by the gas in the test hole on the first flexible sealing device with controllable volume variation, wherein the test pressure F_{g} is equal to a normal stress at a bottom of the first flexible sealing device with controllable volume variation multiplied by a contact area S₂ between the gas and the flexible sealing device with controllable volume variation, where S₂=π(r₂²−r₁), so that F_{g}=P_{g}−S₂=π(r₂²−r₁²)P_{g},
so that, when F_{g}≤F_{f}, no gas leakage occurs, namely, π(r₂²−r₁²)P_{g}≤2uπr₂hP₁π(r₂²−r₁²)P_{g}≤2uπr₂hP₁, and π(r₂²−r₁²)P_{g}≤2uπr₂hP₁ is simplified to
$${P}_{1} \geq \frac{( {r}_{2}^{2} - {r}_{1}^{2} )}{2 {ur}_{2} h} \cdot {P}_{g} ;$$
S2.14, selecting 80% the lateral area of the first flexible sealing device with controllable actual volume variation to ensure an effective sealing area, namely, F_{g}≤0.8 F_{f}, simplifying π(r₂²−r₁²)P_{g}≤2uπr₂hP₁ to
$${P}_{1} \geq \frac{( {r}_{2}^{2} - {r}_{1}^{2} )}{1.6 {ur}_{2} h} \cdot {P}_{g} ,$$
wherein when the pressure of the first flexible sealing device with controllable volume variation and the test pressure in the test hole satisfy Formula (1), the sealing is effective.
